(19) United States
(12) Patent Application Publication
(10) Pub. No.: US 2008/0312883 A1
(43) Pub. Date: Dec. 18, 2008

(54) Method and Apparatus for Determining a Unique System Condition

(75) Inventor: Philipp Walter Klaschka, Bethpage, NY (US)

Correspondence Address: HOFFMANN & BARON, LLP, 6900 JERICHO TURNPIKE, SYOSSET, NY, 11791, US

(73) Assignee: FESTO AG & CO, Esslingen (DE)

(21) Appl. No.: 11/762,474

(22) Filed: Jun. 13, 2007

(51) Int. Cl. G06F 17/00

(52) U.S. Cl. 703/2

(57) ABSTRACT

A method and apparatus of determining a unique condition in a cyclic system. A set of system variables and a sample time are defined. The variables varying between a first and second state. The system is operated for more than one cycle, and a data array based on system variables and time is created. A processor analyzes the data array for changes in the variables, and generates arrays responsive to the changes in the variables. The arrays are analyzed to determine a unique set of variable conditions.

### FIELD OF THE INVENTION

The present invention relates to a method and apparatus for determining a unique condition in a system and in particular for determining a unique condition in a cyclic system.

### BACKGROUND OF THE INVENTION

In a cyclic system, such as a fluid power system, various steps or events occur during a system cycle. For example, valves shift, and actuators are selectively pressurized causing movement resulting in position sensors being activated. The various steps may be controlled by a programmable logic controller (“PLC”) or other controllers both digital and analog. In a cyclic system, these events are repeated in the same sequence in each cycle. This repetitive nature permits data collected from one cycle to be compared to subsequent cycles. Variations in the data can be used to determine the operational fitness of the system. One such diagnostic system is set forth in U.S. Pat. No. 7,031,850.

If it is desired to compare one cycle to another, it is important that the cycle length be accurately defined so that like information is being compared. For example, if a cycle is defined as having 10 events, and then the cycle is repeated, the 10 events of one cycle need to be compared to the same 10 events from a subsequent cycle if meaningful comparison data is to be generated.

In a cyclic system, one way of determining a cycle length is to rely on the programming of a PLC. A PLC program will typically include a series of steps that are to be completed within a cycle. When the cycle is completed, the PLC will again initiate the beginning of the next cycle. The PLC can be programmed to generate a signal when the cycle begins, or ends. This signal can be used by a diagnostic unit which is analyzing data generated during the cycle and looking for variations between the cycles or other information.

However, relying on the PLC requires that the PLC program be modified to cooperate with a diagnostic unit. This can be troublesome for a system that is already in operation, and therefore, requires retrofitting. If a diagnostic unit is to be added to such a machine, the PLC program would have to be modified. Since there are many different types of PLC's in the market, attempting to retrofit a machine with a diagnostic unit may require an installer to be familiar with many different PLC programming codes. In addition, the PLC, due to design or capacity, may not be able to generate the necessary signal.

Accordingly, it would be desirable to provide a method and apparatus for determining the bounds of a cycle system in an efficient and reliable manner.

### SUMMARY OF THE INVENTION

It is a feature of the present invention to provide a method and apparatus for determining a unique condition in a system cycle.

It is also a feature of the present invention to provide a method and apparatus for determining a unique condition in a digital data array.

It is a further feature of the present invention to provide a method and apparatus for determining the bounds of a cycle based on determining a unique event through analyzing a digital data array.

The present invention provides a method of determining a unique condition in a cyclic system including the steps of:

defining a set of system variables and a sample time, the variables varying between a first and second state;

operating the system for more than one cycle;

creating a data array based on system variables and time;

analyzing the data array for changes in the variables;

generating arrays responsive to the changes in the variables; and

analyzing the arrays to determine unique set of variable conditions.

The present invention also provides a method of determining a unique condition in a system including the steps of:

defining a set of system variables and a sample time, the variable having a first and second state;

operating the system for a period longer than one cycle;

sampling data generated by the system variables during the system operation;

creating a first data array based on the system variables and time;

analyzing the first data array for rising and falling edges of the variables;

for at least one of the variables, at each rising edge and each falling edge saving a condition of each the variables at the time of the rising and falling edges in condition sets;

for each rising edge comparing the condition sets to each other; deleting the condition sets which are the same;

for each falling edge comparing the condition sets to each other;

deleting the condition sets which are the same; and

selecting one of any remaining condition sets to determine the unique system condition.

The present invention further provides an apparatus for determining a unique condition in a cyclic, system including a data acquisition device operatively connected to a plurality of system elements that form system variables. A data storage device is provided for storing data collected by the data acquisition device. A processor is operatively connected to the data storage device. The processor creates a first data array responsive to the system variables and time and analyzing the data array for changes in the system variables. The processor generates a plurality of second arrays responsive to the changes in the variables and analyzes the second data arrays to determine a unique set or sets of variable conditions.

### BRIEF DESCRIPTION OF THE DRAWINGS

FIG. 1A is a flow chart of the method of the present invention.

FIG. 1B is a continuation of the flow chart of FIG. 1A.

FIG. 2 is a schematic of a cyclic fluid power system.

FIG. 3 is a data array based on system variables at various times in the cycle.

FIG. 4 is a simplified data array derived from the data array in FIG. 3.

FIG. 5 is a data array of rising edges of variable 3 derived from the data array of FIG. 4.

FIG. 6 is a data array of falling edges of variable 3 derived from the data array of FIG. 4.

FIG. 7 is the data array of FIG. 4 showing a time variable.

FIG. 8 is a data array of variables over time showing rows having the same conditions.

FIG. 9 is a data array of variables with one variable being constant.

FIG. 10 is a data array of variables showing two variables being constant.

### DETAILED DESCRIPTION OF THE PREFERRED EMBODIMENTS

The present invention collects and analyzes data generated during the operation of a system in order to determine a condition or set of conditions that occurs only once during a system cycle. By determining such a unique condition, the bounds of the cycle can be determined. When the unique condition occurs, this can be set as the beginning of the cycle. When the unique condition occurs again, this marks the end of the cycle and the beginning of the next cycle. The unique condition can be used in conjunction with other systems in which knowing the bounds of a cycle is desirable.

In a diagnostic system which compares the data from one cycle to the next, the ability to define the cycle is important. This way, like data sets are compared and variations between the data sets can be used to provide meaningful information. For such a comparison, it is not necessary that the unique condition occur at the very beginning of a machine operation or the first step in the machine's operation. In a cyclical system, the events in one cycle are the same as every other cycle. Therefore, there is a consistency between cycles. Due to the repetitive nature of a cyclic system, any unique condition during the cycle could be determined to be the “beginning”. The “end” of the cycle occurs when the unique condition comes up again. With the beginning and end of a cycle so defined, the events occurring in each cycle should be the same. This permits a complete set of data from one cycle to be compared to a complete set of date from a subsequent cycle. Variations between the data sets can be used to provide information about the system, such as the condition of the system components.

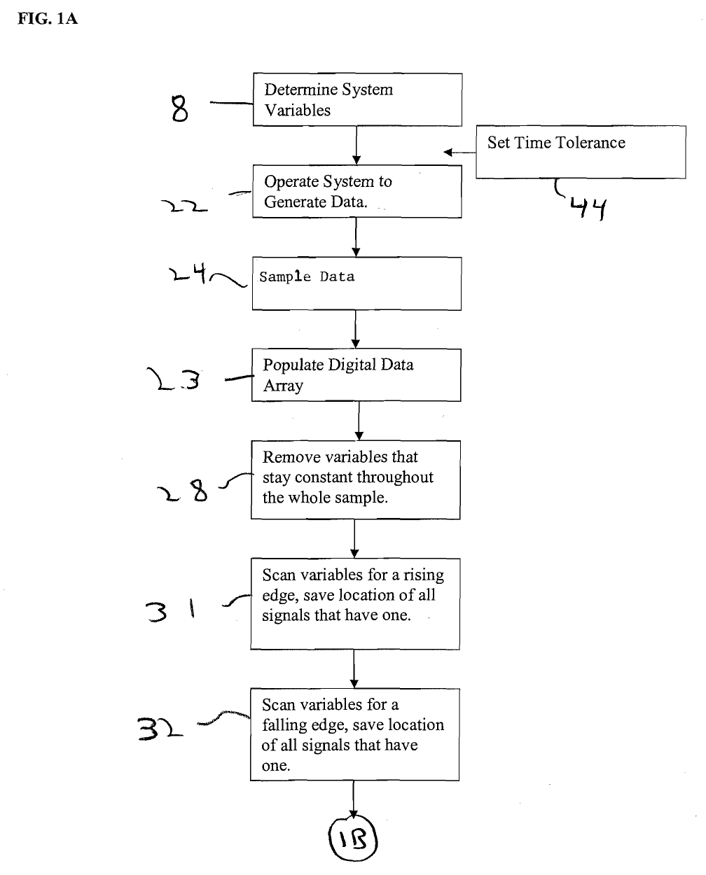

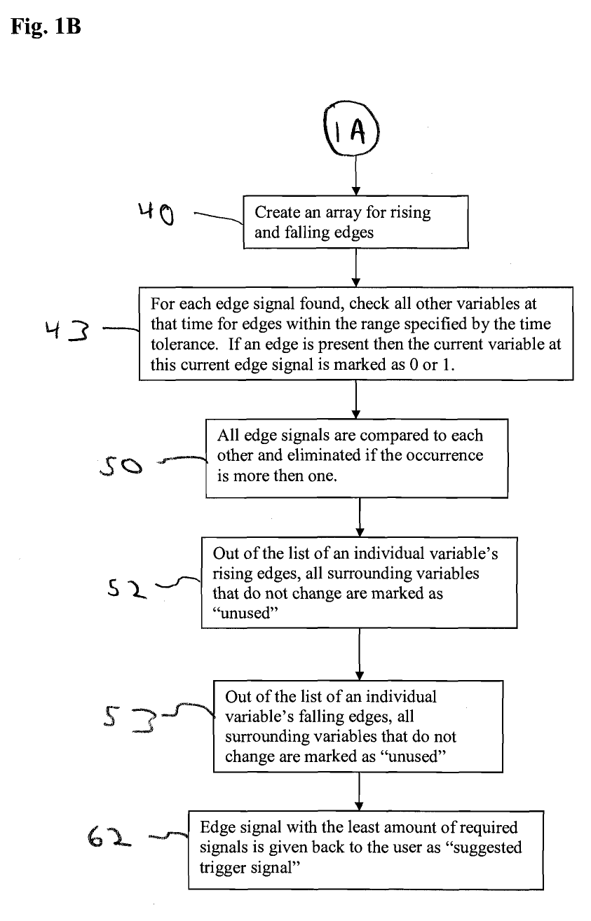

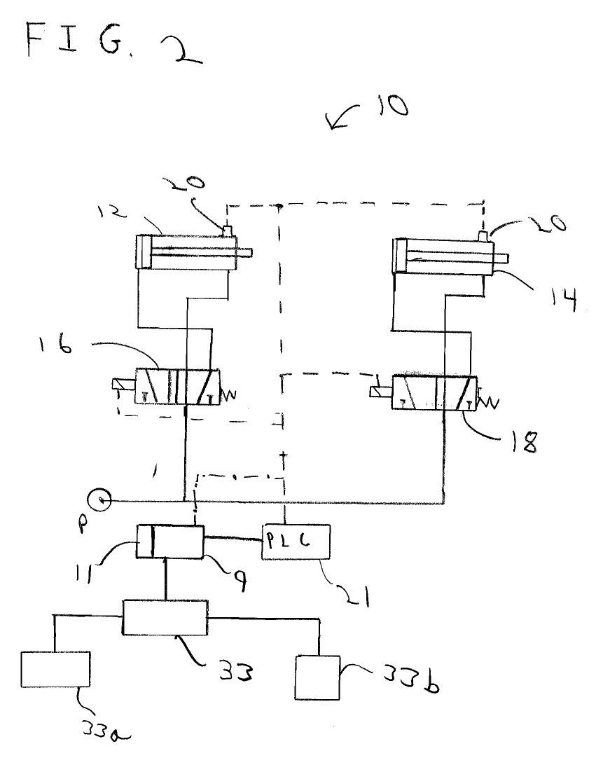

The present invention includes a method preferably including a plurality of steps as set forth in FIGS. 1A and B. The method determines one or more unique system conditions in a system cycle. The unique condition can be used to determine the bounds of the cycle. In a preferred embodiment the method includes defining system variables, step 8. A system variable is an element that may change during the system cycle. For example with reference to FIG. 2, a fluid power system 10 has various elements including actuators 12 and 14, valves 16 and 18 and actuator position sensors 20. While a fluid power system is described, the present invention may be employed to determine a unique condition in other types of systems. The valves and sensors may be operably connected to a controller 21 such as a PLC or other processor or control system. The variables are sampled at discrete time intervals during the operation of the system. The sampling rate may be set by a user. The data may be collected by a data acquisition device 9. The device may be in the form of one or more data loggers having a number of channels to accommodate the number of variables. The data acquisition device 9 may include memory forming a data storage device 11, or the data storage device may be separate from and operably connected to the acquisition device 9. Alternatively, the data storage device may be performed partially by memory in the data acquisition device and a separate memory unit. The data acquisition device 9 may be operatively connected to the PLC 21 and/or directly to the system elements. In addition, the data acquisition device could he part of the PLC.

A valve may be switched between a first and second position, therefore, each of the valves constitute a system variable that may be digitally represented as having a 0 or 1 state. The signal used to switch the valve will be either on or off, and this is used to determine the state of the valve. Such a signal may be operatively connected to the data acquisition device 9. The position sensors activated by the movement of an actuator also constitute system variables and can be digitally represented as an off, 0, or on, 1, state. The signal generated by the position sensors may also be operatively connected to the data acquisition device 9. For the system shown in FIG. 2 there would be 4 variables. Signals corresponding to these variable may be used to determine the state of the variable. These signals may be processed or analyzed by a processor 33, such as a microprocessor, PC or the like. If the PLC 21 has the sufficient processing power, it could also perform the signal processing. The processor 33 may be operatively coupled to an input device 33a and a display 33b. It is also within the contemplation of the present invention that the data acquisition device and processor could be part of a system diagnostic unit which determines the operational fitness of the system.

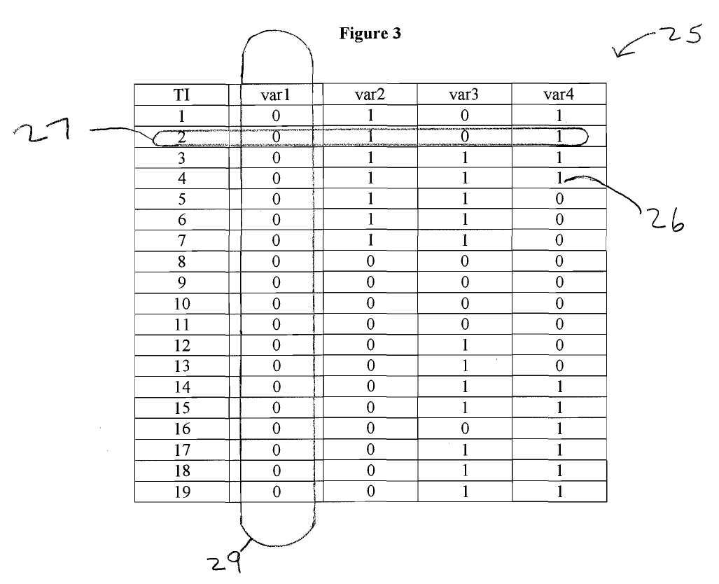

With the variables defined, the system may be run for more than one complete cycle to generate data, step 22. Each change in a system variable constitutes an event in the system. Running the system for such length ensures that a complete cycle has elapsed and all the events in the cycle are detected. During this running of the system, signals corresponding to the variables are sampled at a predetermined sample rate, step 24, by the data acquisition device. The data obtained may be transferred from the data acquisition device 9 to the processor 33 and used to populate a digital array, step 23. A digital array 25 with data points 26 is shown in FIG. 3. In a preferred embodiment, the data may be loaded into a software program of the type used to analyze arrays of data such as EXCEL®, or MATLAB®, or custom C, C++ programs. However, it is within the contemplation of the present invention that other software as is known in the art could be employed. Such a program would be run by the processor 33. For the example of FIG. 3, the system digital data array 25 may include variables 1, 2, 3 and 4, with the data points 26 showing the state of the variables over a series of discrete time intervals (“TI”) corresponding to the sample rate. The set of variables for each time interval may be referred to as a condition set 27. As set forth below, the various condition sets are analyzed to determine if there are certain condition set or sets that occur only once during a system cycle making them unique.

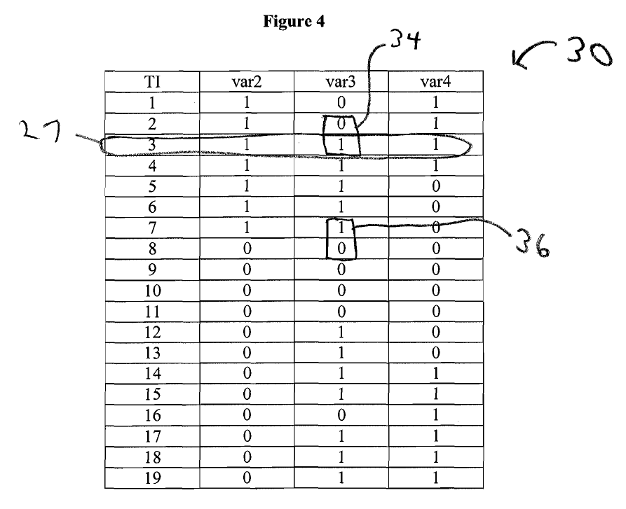

In the preferred embodiment, once the digital data array 25 is populated, it is analyzed by the processor 33 to remove variables that remain constant through the data array, step 28. If a particular variable remains constant, it will not be helpful in identifying a unique condition set since it is the same for all. Therefore, the data for the constant variable may be dropped or marked as unusable in order to assist in simplifying the further analysis. As shown in FIG. 3, variable 1 remains constant at 0; therefore, this variable and the corresponding column 29 in the data array need not be considered and is removed from further analysis. This may be done by creating a new array 30 which does not include the invariant column, var1, as shown in FIG. 4.

With reference to FIG. 4, the remaining data for variables 2 through 4 is analyzed by the processor to find changes in the signal state of the variables, steps 31 and 32. Such changes are referred to herein as the rising and falling edges. A rising edge occurs when a variable changes from state low to high, or 0 to 1, and a falling edge is a change of state of the signal from high to low, or 1 to 0. For example, with respect to variable 3, a rising edge 34 occurs at time interval TI 3, and a falling edge 36 occurs at TI 8. When an edge is identified, the condition set 27, which includes the state of all the variables at that time, is saved in the processor's memory and used to form a further array. This analysis is preferably performed on every variable to determine all rising and falling edges.

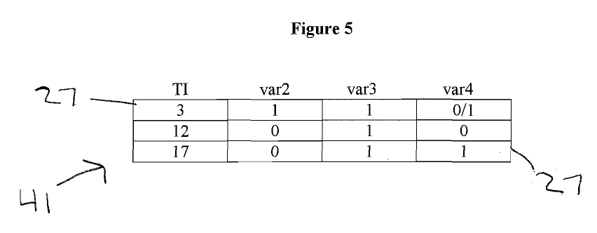

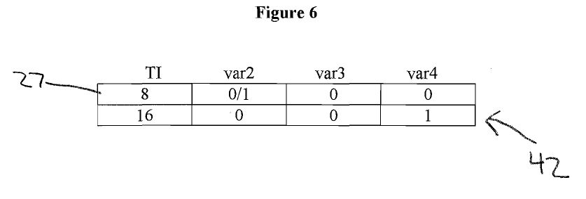

For each of the variables, an array of rising edges and falling edges is created, step 40. As shown for example in FIG. 5, the array 41 is derived from array 30 and includes the condition sets 27 including all the variables at the time when variable 3 has a rising edge. FIG. 6 shows the array 42, derived from array 30, including the conditions of all the variables at the time when variable 3 has a falling edge. Such arrays are preferably also created for the other variables. Therefore, for each time a variable changes state, the set of conditions for all the variables is known. This data, is then analyzed to determine condition states which are unique.

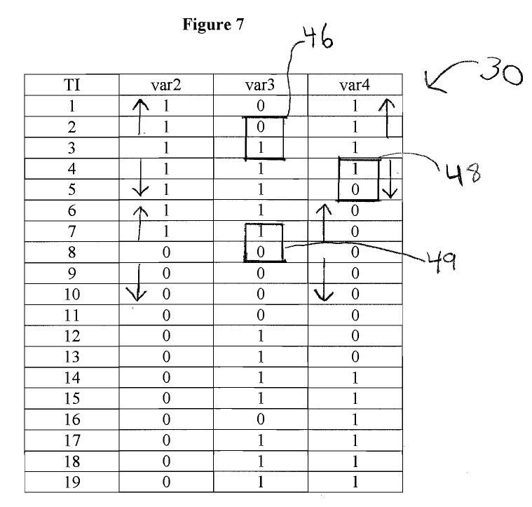

In a preferred embodiment, either before or after the array of rising and failing edges is created, additional analysis, step 43, on the data array 30 may be performed to improve the robustness of the methodology. Due to tolerances in a fluid power system and in the recording of data by the data acquisition device, events may occur, or be recorded as occurring, at slightly different times from one cycle to the next. Therefore, a variable may change state at slightly different times between system cycles. In order to address these variations, in a preferred embodiment, a time tolerance may be set by an operator, step 44, at any time in the process prior to the analysis of step 43. After a variable changes state, i.e., rising or failing edge, the other variables in the condition set are analyzed at a predetermined amount of time before and after the edge. If the other variables change state within the time tolerance range, the actual state of the variable cannot be certain, i.e., it could be either 0 or 1. Therefore, that variable may be assigned to have a state of 1 or 0, step 43. For example, as shown in FIG. 7 at TI 3, variable 3 changes from 0 to 1 constituting a rising edge 46. At TI 3, variable 2 is 1 and variable 4 is 1. Using a sample rate of 5 ms and time tolerance of 10 ms, the state of variable 2 is examined at 10 ms before and after TI 3, which is TI 2 and 1 and at TI 4 and 5. This examination shows that variable 2 has remained constant over TI 1 to 5. Variable 4 is also examined 10 ms before and after rising edge of variable 3. This examination shows that at TI 5, variable 4 changed from 1 to 0, 48. Since this change is within the time tolerance of 10 ms, it is possible that variable 4 could be a 1 or a 0. Therefore, in the array 41 of variable 3 rising edges (FIG. 5), variable 4 is represented as 0/1 in the affected condition set 27.

Variable 3 has a falling edge 49 at TI 8. Examining the other variables at that time shows that variable 2 has a change within the 10 ms tolerance. Therefore, variable 2 could be 0 or 1. With this information determined, the array 42 of variable 3 falling edges (FIG. 6), variable 2 is represented as 0/1 in the affected condition set 27. This process is preferably performed on all variable rising and falling edge arrays.

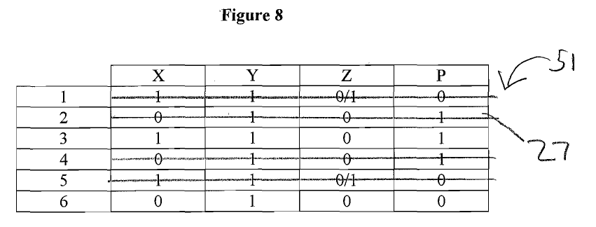

The arrays of falling edges and rising edges are then analyzed, step 50, to remove any conditions sets or rows that are the same. The condition sets are compared and if a condition set repeats itself, meaning it occurs more than once during a cycle. It is not unique and does not help define the bounds of a cycle. For example, with reference to FIG. 8, a sample data array 51 of rising edges of a variable Y is shown. Rows 2 and 4 have the same condition sets. Therefore, they can both be removed from further analysis. In performing this analysis, variables that could be 1 or 0 are analyzed using both variations. Therefore, a row with conditions 1, 1, 0/1, 0 could be 1, 1, 0, 0 or 1,1, 1, 0. Accordingly, rows 1 and 5 are also the same and can be eliminated. By analyzing the row using both possible conditions, the accuracy of the system is improved and the ability to find the unique set of conditions is increased. The analysis indicates that the condition sets of rows 3 and 6 are unique. This process is preferably performed on all variable rising and falling edge arrays.

After rows of similar conditions are eliminated, the remaining row(s) indicate unique sets of conditions for the system that occur only once a cycle. One of these condition sets may he used to establish the beginning and end of the cycle. A unique condition set may be transformed into a conditional statement for use in a program which needs to determine the bounds of a cycle. For example, with reference to FIG. 8, which is rising edges of variable Y, if a unique condition is variable X 1, variable Y 1, variable Z 0, variable P 1, the conditional statement may be as follows:

IF var X AND var Y low to high AND NOT var Z AND var P THEN generate beginning of cycle signal.

In the conditional statement, one of the conditions is the changing event, such as a variable going high to low, or low to high. This permits the conditional statement to identify a specific moment in time. In the above example, since the array used is rising edges of variable Y, the Y condition is low to high.

In practice, a data array could include thousands of data points. For example, if a system has 40 variables and the cycle is sampled every 5 ms, even a cycle running for only a minute creates an array of 480,000 data points. In such a system having many variables with a large data array, it is likely that there will be a number of unique condition sets in a system cycle. Therefore, in a preferred embodiment, the arrays including the list of unique conditions established for the rising edges and falling edges for each variable are analyzed to simplify them in steps 52 and 53. If in an array, a variable column has all the same condition, it does not distinguish one condition set from another. Therefore, it is not necessary and can be eliminated.

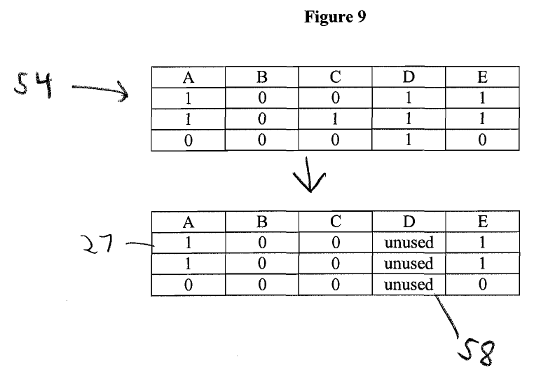

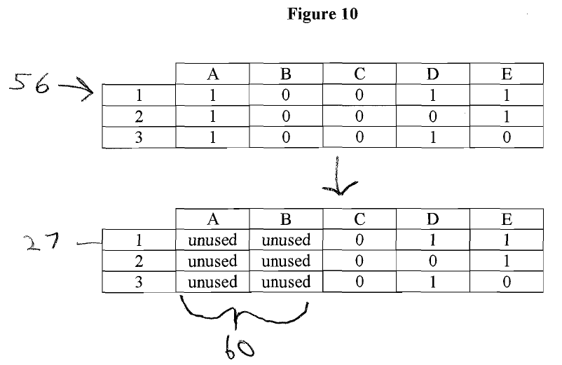

FIGS. 9 and 10 show examples of data of a system having variables A through E. The array of variable B's falling edge 54 is shown in FIG. 9 and the array of variable C's falling edges 56 is shown in FIG. 10. In FIG. 9, variable D remains constant. Therefore, it can be marked as unused, 58. In FIG. 10, variables A and B stay the same. Therefore these columns 60 can be marked as unused, since if a variable is always the same value it does not assist in differentiating between the different condition sets. It is noted that the variable from which the array is made, e.g., falling edges of variables B and C, the variables B and C will always be 0, in their respective arrays. This column is still used even though it remains constant.

After all the rising and falling arrays are analyzed to eliminate constant variables, the condition set having the fewest remaining data points is chosen as the suggested trigger to indicate the beginning of a cycle at step 62. This results in the most concise conditional statement. For example, the array of FIG. 10 can be reduced to a condition set having only 3 variables. This is in contrast to the array of FIG. 9 which has 4 variables. Therefore, it would be more preferable to choose a condition set from the array of FIG. 10. In the event that the fewest number of data points is shared by more than one condition set, one of the groups of the condition sets may be chosen either at random or by an operator. The conditional statement will be created that sets forth a unique set of conditions that only occurs once per cycle. This statement may be used to mark the beginning and end of a cycle.

The present invention has been described herein with respect to a cyclic fluid power system. However, the present application is not limited to such a system and can be employed to determine a unique condition in digital data generated by other systems or in other manners.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A method of determining a unique condition in a system comprising the steps of:
defining a set of system variables and a sample time, the variable having a first and second state;
operating the system for a period longer than one cycle;
sampling data generated by the system variables during the system operation;
creating a first data array based on the system variables and time;
analyzing the first data array for rising and felling edges of the variables;
for at least one of the variables, at each rising edge and each falling edge saving a condition of each the variables at the time of the rising and falling edges in condition sets;
for each rising edge comparing the condition sets to each other;
deleting the condition sets which are the same;
for each falling edge comparing the condition sets to each other;
deleting the condition sets which are the same; and
selecting one of any remaining condition sets to determine the unique system condition.

2. The method as defined in claim 1, further comprising the step of deleting from the first data array any variable that does not change state during the system operation.

3. The method as defined in claim 1, for each of the variables, at each rising edge and each falling edge saving the condition of each of the variables in condition sets.

4. The method as defined in claim 3, wherein the condition sets for each variable form a rising edge array and a falling edge array.

5. The method as defined in claim 4, further comprising the steps of setting a time tolerance and upon detection of a rising or falling edge of a variable, analyzing other variables to determine if there is a change in state within the time tolerance.

6. The method as defined in claim 5, wherein in response to the analyzing the other variables if there is a change in state of a variable within the time tolerance, assigning that variable as being in either the first or second state in the rising and falling edge array.

7. The method as defined in claim 1, further comprising the step of creating a conditional statement based on the selected remaining unique conditional set.

8. The method as defined in claim 1, wherein the variables generate signals providing digital data, and the first array is populated with digital values.

9. The method as defined in claim 1, wherein the arrays are processed on a spreadsheet software program.

10. The method as defined in claim 1, further comprising the step of analyzing the rising and falling edge data arrays, and eliminating variables which remain constant.

11. The method as defined in claim 10, wherein selecting the remaining unique condition sets further comprising the step of determining the unique condition set having the fewest variables and selecting that unique condition set.

12. A method of determining a unique condition in a cyclic system comprising the steps of:
defining a set of system variables and a sample time, the variables varying between a first and second state;
operating the system for more than one cycle;
creating a data array based on system variables and time;
analyzing the data array for changes in the variables;
generating arrays responsive to the changes in the variables; and
analyzing the arrays to determine a unique set of variable conditions.

13. The method as defined in claim 12 wherein for at least one of the variables, for each change in state saving the condition of each of the variables in condition sets.

14. The method as defined in claim 12, further comprising the step of generating a conditional statement based on a determined unique set of variable conditions.

15. An apparatus for determining a unique condition in a cyclic system comprising:
a data acquisition device operatively connected to a plurality of system elements that form system variables;
a data storage device for storing data collected by the data acquisition device;
a processor operatively connected to the data storage device, the processor creating a first data array responsive to the system variables and time, and analyzing the first data array for changes in the system variables, the processor generating a plurality of second data arrays responsive to the changes in the variables and analyzing the plurality of second data arrays to determine a unique set or sets of variable conditions.

16. The apparatus as defined in claim 15, wherein the processor determines one unique set of variable conditions and generates a conditional statement responsive to the unique set of variable conditions.

17. The apparatus as defined in claim 15, further including an input device operatively coupled to the processor.

18. The apparatus as defined in claim 15, further including a display device operatively coupled to the processor.

19. The apparatus as defined in claim 15, wherein the processor utilizes a spreadsheet soft ware program.

20. The apparatus as defined in claim 15, wherein the processor analyzes the first data array for rising and falling edges of the variables, and for at least one of the variables, for each rising edge the processor saves a condition of all the variables at the time of the rising edge in a condition set, for each falling edge the processor saves a condition of each of all the variables at the time of the falling edge in a condition set.

21. The apparatus as defined in claim 20, wherein the processor for each rising edge compares the condition sets to each other and deletes the condition sets which are the same; and the processor for each failing edge compares the condition sets to each other and deletes the condition sets which are the same; and the processor selects one of the remaining rising and falling edge unique condition sets to determine the unique system condition.

22. The apparatus as defined in claim 20, wherein the processor wherein the processor analyzes the first data array for rising and falling edges of the variables, and each of the variables.

23. The apparatus as defined in claim 20, wherein the processor in response to a predetermined time tolerance assigns a variable as having more than one value.

24. The apparatus as defined in claim 20, wherein the rising edge condition sets constitute one of the plurality of second data arrays and the falling edge condition sets constitute another one of the plurality of second data arrays.
